(19) United States
(12) Patent Application Publication
(10) Pub. No.: US 2004/0205576 A1
(43) Pub. Date: Oct. 14, 2004

(54) System and method for managing Knowledge information

(76) Inventors: Bill S. Chikirivao, Denver, CO (US); Craig K. Hurst, Highlands Ranch, CO (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/125,119

(22) Filed: Apr. 17, 2002

Related U.S. Application Data
(60) Provisional application No. 60/359,923, filed on Feb. 25, 2002.

(51) Int. Cl. G06F 17/24

(52) U.S. Cl. 715/513; 715/500

(57) ABSTRACT

A system and method for converting an extensible markup language (XML) file, such as a WellXML™ file, to data elements that are accessible by a server. In one example, an XML file is received and the type of data provided in the XML file is determined. At least one metafile is identified as associated with the type of data determined by the determining operation, wherein the metafile specifies one or more parameters present in the type of data determined by the determining operation. One or more data elements in the XML file are identified as corresponding to the one or more parameters, and an output file is generated which includes the one or more data elements. The output file may be stored on a server accessible by clients in a network. In this manner, a large number of files converted into XML or the like can be made accessible over a network.

### CROSS REFERENCE TO RELATED APPLICATIONS

This application claims priority under 35 U.S.C. 119(e) to U.S. provisional patent application Serial No. 60/359,923 filed Feb. 25, 2002 entitled “OPERATIONAL EVENT SUMMARY” the disclosure of which is hereby incorporated by reference in its entirety. This application is further related to U.S. provisional patent application Serial No. 60/284,068 entitled “SYSTEM AND METHOD FOR MANAGING KNOWLEDGE INFORMATION” filed Apr. 16, 2001, and to U.S. provisional patent application Serial No. 60/284,077 entitled “SYSTEM AND METHOD FOR DEVELOPING RULES UTILIZED IN A KNOWLEDGE MANAGEMENT SYSTEM” filed Apr. 16,2001, the disclosures of which are hereby incorporated by reference in their entirety.

### FIELD OF THE INVENTION

The present invention relates to the field of automated business management tools and methodologies. More specifically, the present invention relates to the field of managing information utilized in developing and administering complex projects and/or processes.

### BACKGROUND OF THE INVENTION

Information for engineers, cross-functional teams, executives and other users to plan, administer, manage, and complete projects and processes is typically created in multiple software applications and maintained in files and locations that are inconvenient to utilize and/or access. Often such information, which, for example, may include well operations reports (for example, daily drilling reports, completion reports, work over reports, and activity logs/events), project parameters, scheduling information, technical specifications, change tracking, vendor/supplier relationship management and feedback, requests for quotes and proposals, requests for service, daily reports, performance reviews and more is often stored on paper in file cabinets.

Such information often may not be readily accessible to team members and others because of its format, storage location, identification and accessing schemes (i.e., how the information is filed in the cabinets, identified and then retrieved for review). With the advent of computerized filing systems, such information has been relocated from the physical file cabinets of the past to the virtual file cabinets of the present (which are suitably hosted on electronic and computer based client-server databases and systems). However, the difficulties inherent in identifying, accessing and retrieving such information (whether physically or virtually stored) have not been overcome and instead have been shifted from physical searching to virtual searching.

Further, current systems and processes do not provide the needed capabilities to mine such information, after it has been identified and retrieved, in a convenient, easily accessible and beneficial manner. Thus, there is a need for systems and processes which enable users to quickly and efficiently access, manipulate, utilize and exploit information concerning projects, operations and processes on a real-time basis.

Further, current systems and processes do not enable users to quickly, and/or on a real-time basis, document the performance of a project or operation with which they are involved (for example, the status of an oil well drilling project). In short, current systems do not enable users to document project details “on the fly.” Similarly, access to historic project information (e.g., for a past and similar well drilling project in the area) is often problematic and does not allow users to quickly obtain the historic performance and/or operational parameter information which may be of value to the user and ultimately the success of the project. Further, a system which allows such users to access the information and present/reformat the information in a useful/desired format (for example, in a graphical format) is needed.

Additionally, a system is needed which reduces the amount of time necessary to plan complex projects. In the oil and gas industry, for example, engineers often spend considerable time researching well files when planning to conduct operations on existing wells and/or developing new wells. For example, when planning a new well, an engineer will often research well files of “offset” wells to determine the costs, time to perform, and the hazards experienced during operations. This information is commonly accessed via paper or electronic files without any expert systems assistance. The information accessed is then used to plan a new well in hopes of minimizing the risks associated with the new well. Such information is then commonly only accessible by researching an existing well's file and does not provide readily accessible information on similarly situated projects. Thus, a need exists for a knowledge management system which enables users to research, identify and utilize information from like projects and not just from those projects with which they already know about or have to conduct an extensive search in order to so identify.

It is against this background that various embodiments of the present invention were developed.

### SUMMARY OF THE INVENTION

According to one embodiment of the invention, disclosed herein is a system and process which provides engineers, cross-functional teams, executives and other users with the ability to document and exploit a company's operations and performance details for a project, operation or process in real-time from anywhere in the world over the Internet or a similar network. In one example, the present invention provides a foundation for an intelligent electronic filing system and process which may be utilized, for example, to obtain and provide information on an oil and gas well project.

In one embodiment in the context of the oil and gas industry, the system may provide a well repository (i.e., a database containing information relating to at least one well) as part of an intelligent electronic knowledge management system. As described further herein below, in one embodiment the well repository integrates various pieces of data and information received by a centralized, integrated web-based data application system.

According to one broad aspect of another embodiment of the invention, disclosed herein is a method for converting an extensible markup language (XML) file, such as a WellXML™ file, to data elements accessible by a server. In one example, the method includes receiving an XML file, determining a type of data provided in the XML file, and identifying at least one metafile associated with the type of data determined by the determining operation, wherein the metafile specifies one or more parameters present in the type of data determined by the determining operation. One or more data elements in the XML file are identified as corresponding to the one or more parameters, and an output file is generated which includes the one or more data elements. The output file may be stored on a server accessible by clients in a network. In this manner, a large number of files converted into XML or the like can be made accessible over a network.

In an oil and gas embodiment, the present invention enables Engineers and Managers to extract, utilize and present such information pertaining to the exploration, discovery, development and exploitation of oil and gas resources. In one embodiment, such information is provided in a usable format so that timely and intelligent decisions can be made which have a positive influence upon the exploitation of natural resources and especially the development and/or operational performance of current and future wells. In one example, a robust, secure, centralized, web-based database and infrastructure may be provided and can be accessed from anywhere at anytime.

Further, the repository of information may contain operational parameters associated with wells (or other projects/processes) which may be utilized to determine which operational procedures and policies work or do not work for an industry, a specific company, a region, a project or any other level. Comparisons and analytical analyses can be conducted using the system at any time or stage of a process, project or operation from any authorized user. The information necessary to perform such analysis is preferably captured via a secure, centralized well repository structure, in one example. Further, the tools, business rules, operations, engineering rules, procedures and policies necessary to analyze such information may be provided and can be accessed from a suitably equipped system.

It is to be appreciated that various types of information may be suitably received by the system including, for example, work flow information collected by the Wellogix® system navigator on its navigator/Dynamaps™ function, operational data stores (for example, information provided by Landmark Graphics Drilling Information Management System (DIMS) application), and back-office financial systems (for example, SAP via Vitria's™ enterprise integration capabilities). Such information may be provided in an Extensible Markup Language (XML) format such as WellXML™ format or suitably converted into such format. WellXML™ is a subset of XML which is tailored for the oil and gas industry, and provides a flexible and comprehensive interfacing scheme for data structures used to facilitate the transfer of information associated with complex engineering services, drilling related functions between homogeneous and heterogeneous application systems.

Upon receiving such information, such as in the WellXML™ format, the system in one example integrates this information and other information as desired into a database that may be exploited by authorized users for business intelligence purposes, for example, presenting tables and graphs of a well configuration and operational performance thereof, determining the effectiveness of current processes, analyzing results of project strategies, isolating trouble areas, and locating sufficient resources. Other examples include True Vertical Depth versus Vertical Section reports, trouble time versus hole sections reports, and others.

Various embodiments of the present invention may be embodied as computer program products including a computer usable medium and computer readable code embodied on the computer usable medium, the computer readable code including computer readable program code devices configured to cause the computer to perform or effect one or more of the operations described herein.

The features, utilities and advantages of various embodiments of the invention will be apparent from the following more particular description of embodiments of the invention as illustrated in the accompanying drawings.

### BRIEF DESCRIPTION OF THE DRAWINGS

FIG. 1 is a schematic representation of a system in accordance with one embodiment of the invention.

FIG. 2 is a schematic representation of a system architecture in accordance with one embodiment of the invention.

FIG. 3 is a flow diagram of a process utilized by a server to convert WellXML™ formatted data into Object Data Definitions (ODD), in accordance with one embodiment of the invention.

FIG. 4 is an example of a WellXML™ formatted document, in accordance with one embodiment of the invention.

### DETAILED DESCRIPTION

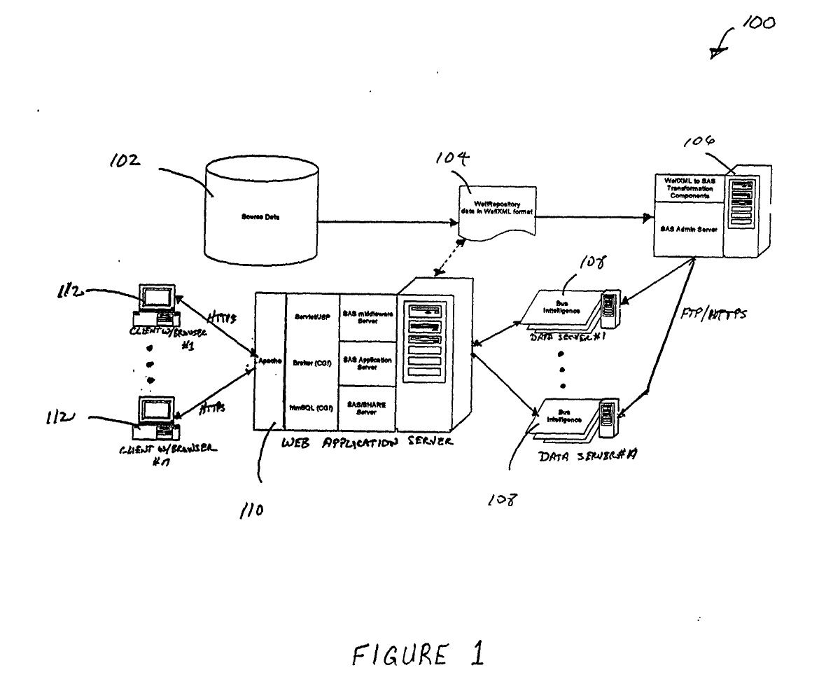

As shown in FIG. 1, in one embodiment the system 100 includes various data entry devices, interfaces, and servers. As shown, source data 102 (for example, daily reports for well drilling information) is suitably input into an instantiation of the web application server 110 which accepts inputted source data from a client, for example, via a web browser over an Internet connection. One example of such a server 110 is as provided by a Wellogix® system which may be accessed via the URL www.wellogix.com. Another embodiment of such a web based data application system is further described in co-pending U.S. patent application Ser. No. 09/672,938, entitled “Process and System for Matching Buyers and Sellers of Goods and/or Services,” filed on Sep. 28, 2000 the contents of which are herein incorporated by reference.

Further, the disclosures of the following co-pending U.S. patent applications are also incorporated by reference in their entirety: U.S. patent application Ser. No. 09/801,016 filed on Mar. 6, 2000, entitled “Method and Process for Providing Relevant Data, Comparing Proposal Alternatives, and Reconciling Proposals, Invoices, and Purchase Orders with Actual Costs in a Workflow Process”; and U.S. Provisional Patent Application Serial No. 60/283,701 filed on Apr. 12, 2001, entitled “Data-Type Definition Driven Dynamic Business Component Instantiation and Execution” along with its corresponding non-provisional application filed Apr. 12, 2002, Serial No. 10/XXX,XXX.

The analytical and other tools described in the patent application entitled “Data-Type Defintion Driven Dynamic Business Component Instantiation and Execution” may also be utilized in conjunction with the present invention. The tools, business rules, operations, engineering rules, procedures and policies, such as described in the patent application entitled “System And Method For Developing Rules Utilized In A Knowledge Management System,” referenced above, may be used to analyze such information and can be accessed from a suitably equipped system.

The server 110 suitably converts the received data from data source 102 into formatted documents, such as in one example WellXML™ documents which are an implementation of XML. One example of the various process steps which may be used to convert source data into WellXML™ formatted data is provided in the patent application entitled “Data-Type Definition Driven Dynamic Business Component Instantiation and Execution,” referenced above.

In one embodiment, the WellXML™ data includes at least two elements: an envelope and informational data. The envelope functions as a wrap on the informational data and preferably provides an indication of a type of data contained therein, the source of the data, the destination of the data (provided, for example, if the data is not to be saved in servers associated with the source) and any other identification and/or routing information necessary. The informational data provides specific parameters associated with a process, routine, request, job, or the like.

The source data 102 may include well planning data as well as information extracted from other reports and information conveyance vehicles, in one example. Examples of the types of source data 102 which the system 100 may receive and process may include: operational reports provided during the lifetime of a well; daily drilling reports; directional surveys which show the profile of a well; time and cost parameters (including trouble time and trouble encountered); drill bit performance parameters; health, safety, and environmental information; completion reports; time and cost parameters; stimulation reports; perforating reports; and wireline reports. The patent application entitled “Method and Automated Process for Matching Buyers and Sellers of Goods and/or Services,” referenced above, describes one embodiment of a system for inputting, saving, manipulating and accessing such information.

It is to be appreciated that the present invention is not limited to using source data 102 provided only by and/or in conjunction with the Wellogix® system and/or an oil and gas embodiment. Other data may be utilized as desired from any source via any information conveyance vehicle, medium or methodology as particular applications of the system and processes of the present invention require.

Once the information 102 is received, the system 100 temporarily stores the information 104 (which has preferably been converted in the WellXML™ format) in tables or views internal to a server 106, such as a SAS warehouse administration server. A SAS warehouse administrator is a tool developed by SAS Institute, Inc. and may use the WellXML™ data definitions to generate or retrieve program files used to create a well repository. In one embodiment, the server 106 suitably converts the WellXML™ formatted data into components, such as SAS transformation components. Such components may include operational data components, such as Operational Data Definitions (ODD) which may be used as inputs to data stores. The ODD represents an archive of original operational data, which may be untransformed from its original legacy format. In one example, ODD components are not used with direct data warehouse querying because ODD components are not in a final format which is quality assured, or because they are too voluminous to be kept in an on-line relational database.

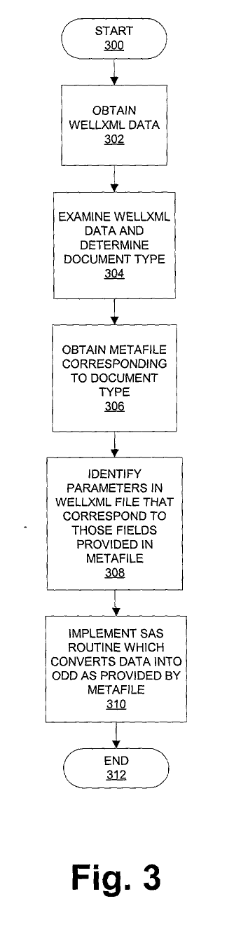

More specifically, FIG. 3 illustrates the process by which WellXML™ formatted data files are converted into components or data elements, such as ODD data, by the server 106 for storage on a data server 108, such as a client server in accordance with one embodiment of the present invention. As shown in FIG. 3, a process begins with obtaining or receiving a WellXML™ formatted data file (step 302). It is to be appreciated that in one embodiment, a WellXML™ formatted data file is provided to the server 106, however, such data may also be obtained upon request of the server 106, for example, when a processing routine being implemented on the web application server 110 requires data that has not been provided and suitably requests the data from a server where the data is known to be stored or provided.

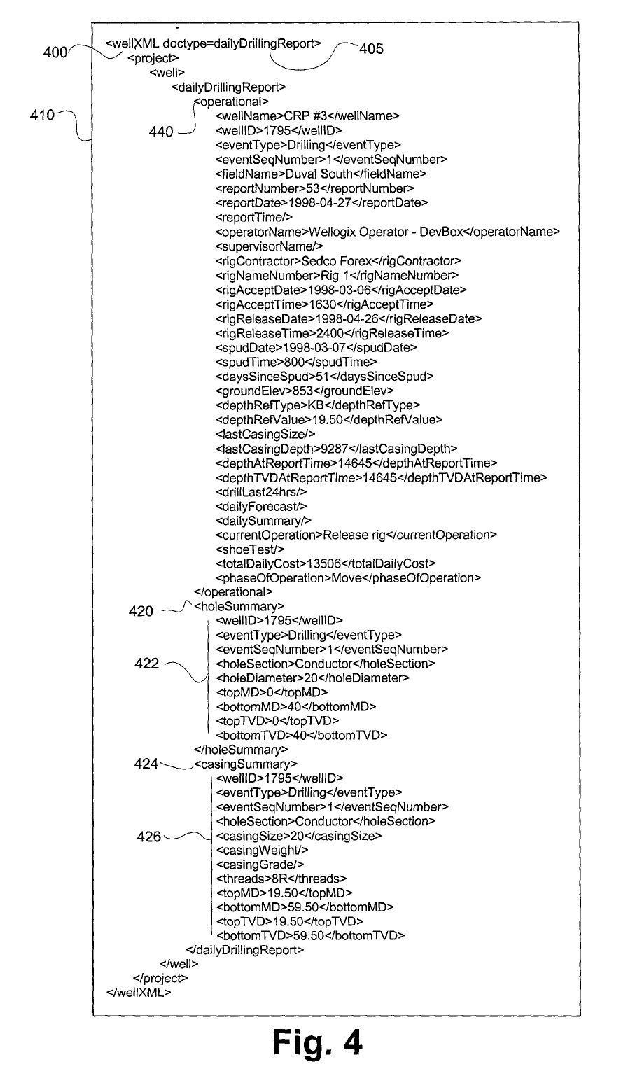

An example of an XML tagged document 410 using WellXML™ tags is shown in FIG. 4. The XML tagged document 410 of FIG. 4 begins with a subset identification 400 of the particular XML subset in which the document is coded, in this case “WellXML™.” Additionally, a document type identifier 410 is present to provide the document type, which is generally industry and XML subset specific. In one example, the document type 410 is a minimal indication to the complex workflow platform of the process requirements for the document. In the example of FIG. 4, the document type is “dailyDrillingReport.” Other tags in the XML tagged document 410 include specific data types 420 (“holeSummary”) and 424 (“casingSummary”), each of which further include multiple data fields 422 and 426 such as input parameters and others. The data types 420, 424 and data fields 422, 426 provide additional information for use in processing the XML tagged document 410. A further XML tag may provide a user profile 340 (“operational”) indicating information about the user that can be used to provide processing routines specific to that user. The data structure of the XML tagged document 410 may be thought of as an “envelope.” The data transferred in the document is wrapped (or enveloped) in XML tags that identify the nature of the document, the identity of the sender, processing instructions, an addressee for transmission, and possibly return address information.

Referring again to FIG. 3, after receiving the WellXML™ data, the processing continues with the server 106 examining the WellXML™ data and determining a document type, i.e., the type of documents to which the data relates (step 304). This document type analysis preferably entails examining header information and/or addressing information provided in conjunction with the WellXML™ data. For example, a WellXML™ file conveying information about a cementing job for Oil Company X would preferably include an envelope identifying the source as Oil Company X, the type of data as cementing, and the informational data might contain an estimate of how many metric tons of cement are specified.

After the server 106 determines the type of data provided in the WellXML™ data file, the server 106 then retrieves a metafile associated with the specific (or in some cases, general) type of data provided (step 306). A metafile may contain various instructions or rules which instruct a server on how to handle and/or manipulate data. In one embodiment of the system, metafiles are suitably created for each type of WellXML™ data received and are accessed as needed. Such metafiles may be stored with the server 106 or elsewhere, and accessed using common protocols and techniques. Upon obtaining the metafile associated with the document type, the server 106 then identifies those parameters in the WellXML™ data file which correspond to those specified in the metafile (step 308). Then the server 106 converts the WellXML™ data into components or data elements, such as ODD information formats, and sends the data to the appropriate data server 108 for storage (step 310).

Additionally, in order to convert the WellXML™ data files 104 into the various ODD transformation components, the server 106 may also validate the information. In one embodiment, validation occurs for three aspects of the information: form, type, and logical. Form validation is the act of mapping the incoming data stream and trying to interpret it into a known data definition. As mentioned previously, the server 106 utilizes specific data maps (i.e., metafiles) to map the data. Such data maps are preferably WellXML™ documents that describe the structure of the Well Repository tables (i.e., the ODD tables) including, for example, table names, column names, column lengths, column valid values and validation rules. These tables are used to store well planning, daily drilling and other information (i.e., source data 102) in the data servers 108. For example, well planning and drilling report maps may be prepared by a drilling engineer for a specific basin and/or region. Such maps are suitably indexed and classified such that, based upon the information 104 received, the server 106 can determine from which other data servers a needed map is to be obtained as necessary.

The server 106 may also perform Type validation, in one embodiment. Type validation is the act of determining whether the data elements are of the correct type. For example, based on the business rules utilized by a specific company (i.e., a client), the size of the drill bit can be specified in the map as a numeric property which is required for all valid drill bit records. During the parsing phase of the WellXML™ document, if the size of the drill bit is not provided and/or the provided size is not numeric, then the associated record fails validation and is preferably placed in an exception file for investigation.

Additionally, the server 106 may also perform logical validation of the received data file 104. During the logical validation phase, the server 106 checks the meaning of specific data fields and their inter-dependencies, to assess logical correctness. For example, a WellXML™ data file 104 containing information relating to a cementing job would verify that the parameters provided relate to cementing and not to some other process, for example, mudding. In one example, such validation is accomplished using look-up tables, matching routines and other filtering/searching tasks.

Further, it is to be appreciated that server 106, as necessary, may also accomplish various additional validations. Such validations may include, for example, authenticity (i.e., validating the source and/or communications links utilized to provide the information), currency (i.e., making sure only current and relevant information will be utilized by the system 100, for example, information provided by erroneous processes or reports may be deleted from the server 106), and other checks. As such, server 106 may accomplish any validations necessary and/or desired. Further, such validations may be accomplished solely by server 106 or by using routines, processes, results, and/or information provided by other servers and systems as necessary.

Once the information 104 has been validated, the server 106 converts the information into the ODD format expected by the specific users of the information. In an oil and gas embodiment, such information is appropriately transformed into well repository information files saved as ODDs on the specified data server 108 or a generic data server 108 when one is not specified. Large organizations may desire to store their data on a server which is not accessible by other clients, whereas smaller organizations may utilize a common server in order to reduce operating costs. Embodiments of the present invention may support any desired dedicated and/or shared server embodiment.

In one embodiment, the validated and transformed data in ODDs are loaded into corresponding tables in the one or more servers 108, which in one example may be well repository detail data servers specific to each customer. Such loading is preferably accomplished using FTP or HTTP, both of which are well known in the art. Once the ODD data is loaded into data server 108, additional rules based processing may be accomplished using the web application server 110 and the stored ODD data. However, in order to know where and what type of information is contained in an ODD data file on the data server 108, the web application server 110 suitably utilizes any metafiles which describe how the WellXML™ information was converted into the ODD. Thus, the web application server 110 and server 106 may share the metafiles as necessary to process the WellXML™ and ODD data files.

Upon identifying, via the appropriate metafile, how the ODD data is organized, the web application server 110 suitably accesses such ODD files and performs the desired processing specified by a client or automatically (for example, reports generated on a periodic basis). The ODD information may also be sent to data marts or a collection of databases which represent summarizations of the information provided in a given set of ODD files, which may have been filtered by the customer. Mining may be accomplished by identifying patterns in the ODD files, such as patterns related to times to perform a given task, true vertical depth information, and other information.

The web application server 110 also may create various output documents, as determined by the client, the system administrator and the particular application of the system. Such output documents preferably utilize, in whole or in part, the information supplied and converted by server 106 into the ODD components and saved on the data servers 108. Examples of such documents include:

Configuration Documents

Wellbore Schematic (i.e., changes during a lifetime of a Well);

Directional Surveys (i.e., sidetracks, multilateral extensions, etc.);

Regulatory Documents

Permitting Documents;

Sundry Notices;

HSE Records

Accident reports;

Spillage reports; and

Environmental cleanup reports.

It is appreciated that other various graphs, charts, reports and other documents may be generated by the system 100 or server 110.

Using this information and other information (for example, information already saved in the system or provided by third parties), the system 100 can conduct various comparisons and analytics using, for example, Wellogix's Internet based analytic tools or other tools to determine what operational procedures and policies work well or do not work well within an operational organization. The system provides the results of such comparisons and analyses to other programs and systems (which may be included as a part or sub-system of the system 100) which can determine which processes or activities are desirable so that business rules can be generated to produce optimal work procedures and policies. In one embodiment, the present invention provides such features by utilizing rule based expert systems that allow for the customization of a company's business, operations, and engineering rules, for example, as described in the co-pending application entitled “System And Method For Developing Rules Utilized In A Knowledge Management System” referenced above.

Further in one embodiment, the system may be designed in accordance with the J2EE industry standard. As is well known in the art, J2EE is an industry standard API for building scalable, secure applications. Leading J2EE application servers in the market today offer built in features like clustering, security, database connection pooling, object pooling, etc. which are proven techniques for scalability and performance. Additionally, in one embodiment the system utilizes Java Server Pages (JSPs) that are designed in a modularized basis such that additional modules may be added and/or deleted depending on particular needs of particular implementations of the present invention. Java servlets are also used to enhance the HTTP request-response process. Such servlets preferably use SAS WebAF's, Information Beans and Middleware servers, all of which are well known in the art, to access data in multi-dimensional stores on the data servers 106 and 110. The Information beans may be Java beans components developed by SAS for accessing data. Also, a SAS Middleware server, provided by the SAS Institute, Inc., may be used so that SAS sessions may be shared amongst multiple users and other features may be provided such as connection caching, load balancing and remote access of SAS applications. Further, a Vitria middleware server may be used to integrate the system with other enterprise application systems. It is to be appreciated that other application programs, interfacing software and/or protocols may also be utilized by the present invention as necessary. As such, the present invention is not limited to these configurations and may utilize other configurations as particular needs require.

Further in one embodiment, the system architecture utilized is suitably scalable by utilizing a clustering approach, wherein the web, business and integration logic tiers are horizontally replicated. Horizontal replication provides fail-over capabilities at the web/application tier. The horizontal replication of these and other components of the system architecture enable the client requests to be distributed amongst any one of the replicated legs, thereby ensuring the system is robust and that multiple tasks and information requests can be simultaneously processed. In one example, each leg within the replicated architecture hosts all logical tiers organized in the same physical tiering model. As such, communications between replicated servers is not needed to satisfy an ordinary business request. Since architectural subsystems that provide clustering, central logging and other functions may need to communicate across the replicated legs, the presentation tiers may be clustered and made known to each other.

Further, the system 100 may utilize an Application Service Provider (ASP) model, wherein a single company hosts data and applications for one or more clients. Clients data are segregated utilizing well known data segregation systems and applications, such that the system 100, in one example, appears to users as multiple separate data marts or collections of databases, wherein each mart contains a user's separate information, some of which may be proprietary.

Users preferably access the system 100 via a suitable Internet connection. However, other network connections may also be utilized as well as providing the system 100 as a stand-alone application. In one embodiment, the service is accessed via a Wellogix portal, an example of which is described in the co-pending patent application entitled “Method and Automated Process for Matching Buyers and Sellers of Goods and/or Services,” referenced above.

Further, a user-to-system web interface (i.e., portal) may be designed to enable personalization of the user experience. As such, the interface recognizes the results of user authentication sent by the portal and manages access to application components based on a customizable user profile, in one example.

As discussed previously, the system 100 in one example may be configured as a multi-tiered application. As is well known in the art, multi-tiered applications utilize an architecture structure that addresses the concerns of scalability, security, volatility and control. The multi-tiered architecture utilized by the system 100 improves system scalability by allocating the correct amount of resources (CPU, memory) to different parts of the system on an as needed/requested basis.

Similarly, the multi-tiered architecture also provides enhanced security capabilities by utilizing presentation codes, which are suitably distributed to client machines/web servers when such client machines/servers are located in less secure environments (for example, an oil drilling platform). This architecture further provides for business logic and business data to be kept behind firewalls on more secure machines, instead of being readily accessible from any machine/server connected to the system. Similarly, system maintainability and reliability is enhanced by the system architecture. The multi-tiered approach allows for sensitive software/data to be separated from non-sensitive software/data.

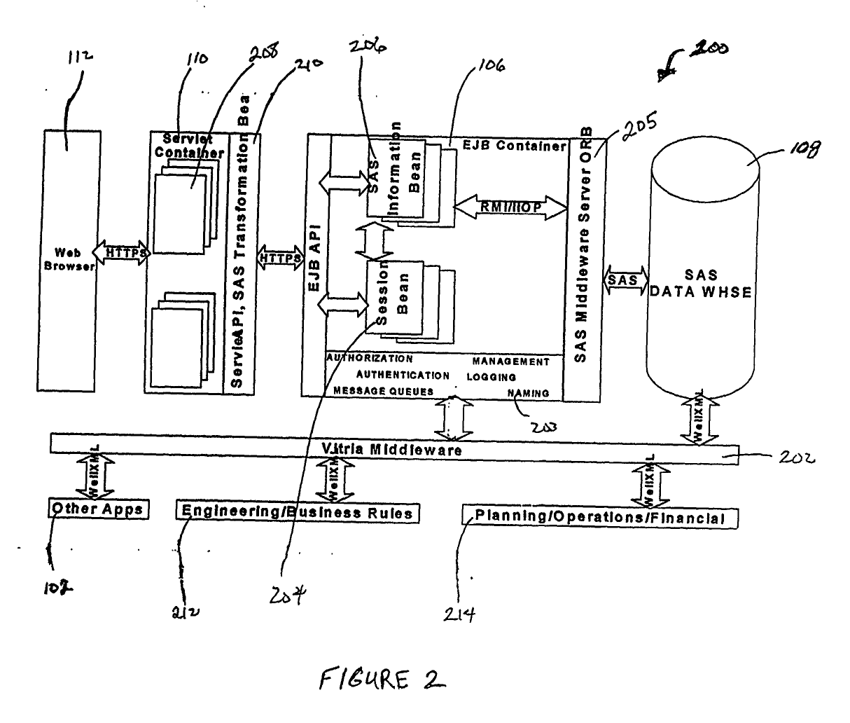

One example of a schematic representation of an embodiment of a system architecture is shown in FIG. 2. As shown, the system 200 may utilize Vitria middleware 202 to facilitate communications between server 106, information sources 102 (such as in the WellXML™ data format 104), and data servers 108 (for example, those providing engineering/business rules and/or planning/operations/financial information and rules). As stated previously, such data interchanges may be accomplished using a WellXML™ format between the source data 102 and the server 106. In one example, an ODD data format is utilized between server 106 and the data servers 108 and with the web application server 110. Further, various other data formats may be utilized to provide engineering, business, financial, planning and/or operational rules 212/214 web application server 110. The generation of those rules 212/214 desired to automate the processes of the system 100 is further described in the co-pending patent application entitled “System And Method For Developing Rules Utilized In A Knowledge Management System,” referenced above.

Further, in one embodiment, the architecture utilizes management software 203 (to control authorizations, management, system logging, message queues and other common functions), session beans 204 and SAS information beans 206. An Enterprise Java Bean (EJB) (i.e., a component model of J2EE) Application Program Interface (APD may be utilized to connect server 106 with the web application server 110 (for example, the Wellogix server) directly or via the data server 108. File transfers between server 106 and the web application server 110 may be accomplished using HTTPs. Those skilled in the art appreciate the various types, forms, throughput and data formats that may be supported using an HTTP transport protocol. However, other transport protocols, including FTP, may be utilized. Similarly, a SAS middleware server Object Request Broker (ORB) 205 may be utilized to interface server 106 with the data servers 108 and/or other databases as necessary.

In one embodiment, the web application server 110 suitably utilizes servlets 208. One servlet for each user session may be provided by the server 110, thereby ensuring data integrity. A servlet-SAS API transformation bean 210 may be utilized by the web application server 110 to complete the communications interface with server 106.

In one embodiment, a web browser 112 is preferably utilized as the user interface. However, APIs may also be utilized in conjunction with or without a web browser, depending in the particular implementation. Those skilled in the art appreciate that web browsers, MicroMedia™ Flash applications, APIs and other interfacing schemes may be utilized as well.

In one embodiment, the user interfaces with the system are web-based, and driven by Java Server Pages (JSPs) and Servlets that utilize a JSP “model 2” framework to separate request processing code from page layout views. This configuration, (i.e., by removing the Java from a JSP) increases the possibility of editing the JSP with a visual tool.

Further, the user interface may also provide client side validation of user-generated input. As is commonly known, one common difficulty with Internet enabled applications is the potential for a significant dependency on the use of JavaScript for client side validation, navigation, and presentation. If a significant portion of the business logic is nested within the JavaScript such that the Document Object Model (DOM) implementations between various browsers are different, minor changes in browser versions may result in different behavior between browser types. This can often result in JavaScript having multiple switch-like statements to determine which browser is being used and how to handle that client. This results in JavaScript that constantly battles new releases of the various browsers since each handles complex behavior differently. To alleviate and/or reduce these difficulties, the system may utilize the general concepts that are common between all versions of DOMs (for example, null and length checking of user form input). However, to avoid the additional workload on the server to handle the validation steps, the system may limit the use of client side JavaScript to the following conditions, in one embodiment:

1. Null field enforcement: prevents submit if a required field is not entered;

2. Coupled null field enforcement: prevents submit if one field mandates the entry of another. For example, it may be required that when entering an address line in a user profile, it is required that a zip code must also be entered before submittal; and

3. Length checking of input. For example, if a username must be greater than 6 characters and less than 10, this could be done client side.

The system may be configured to perform all other validations using Java, either within the servlet interaction framework or at the bean level, i.e., within the web server/application server.

In one embodiment, the system 100 may be implemented using a Sun® computer workstation running Solaris 8 software as the operating system on the database server, server 106 and Web application server 110. Software modules may also be utilized by the database server including, but not limited to, SAS Data Warehouse, SAS/Warehouse Administrator, SAS Integration Technologies, SAS/ACCESS, and SAS Connect. Similarly, server 106 may utilize Base SAS, SAS/CONNECT, SAS/GRAPH, SAS/SHARE, SAS Enterprise Reporter, and SAS/INTERNET. The web server 110 may utilize Oracle 9iAS. The client devices may be configured using Microsoft Windows2000® or the like and a suitable web browser (for example, MS Internet Explorer 5 or Netscape Communicator 4.5). However, other hardware and software may be utilized by embodiments of the present invention to provide one or more of the features and functions identified herein.

While embodiments of the present invention have been shown and described with reference to the oil and gas industry, it is to be appreciated that embodiments of the present invention are not limited to any one or more specific systems, methodologies, applications, environments, projects, or embodiments and may be utilized, as desired, to provide access to real-time information concerning the scope and/or status of a project via any Internet or other suitable communications connection. Examples of other project fields for which embodiments of the present invention may be utilized include, but are not limited to, construction projects, aircraft (or similar equipment) manufacturing, and/or any other activity or process which is of a complex nature.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

While the invention has been particularly shown and described with reference to various embodiments thereof, it will be understood by those skilled in the art that various other changes in the form and details may be made without departing from the spirit and scope of the invention.

1. A method for converting an extensible markup language (XML) file to data elements accessible by a server, the method comprising:
receiving an XML file;
determining a type of data provided in the XML file;
identifying at least one metafile associated with the type of data determined by the determining operation, wherein the metafile specifies one or more parameters present in the type of data determined by the determining operation;
identifying one or more data elements in the XML file corresponding to the one or more parameters; and
generating an output file which includes the one or more data elements.

2. The method of claim 1, wherein the receiving operation further comprises:
receiving, in an application server, at least one data source file; and
converting, at the application server, the at least one data source file into the XML file.

3. The method of claim 2, wherein the receiving operation further comprises:
operating an instance of a web browser in the application server, wherein said instance of the web browser provides for entry of the at least one data source file.

4. The method of claim 1, wherein the receiving operation further comprises:
receiving, in an application server, at least one data source file;
converting, at the application server, the at least one data source file into the XML file; and storing the XML file.

5. The method of claim 1, wherein the XML file includes an XML tag specifying a document type, and the determining operation further comprises:
examining the XML tag specifying the document type.

6. The method of claim 1, wherein the metafile specifies one or more instructions for manipulating the one or more data in the XML file.

7. The method of claim 1, further comprising:
creating a plurality of metafiles wherein at least one metafile corresponds to the type of data in the XML file;
and wherein the operation of identifying at least one metafile further comprises accessing the plurality of metafiles to determine the at least one metafile.

8. The method of claim 1, further comprising:
validating the one or more data elements in the XML file.

9. The method of claim 8, wherein the validating operation further comprises:
performing a form validation operation on said one or more data elements in the XML file.

10. The method of claim 8, wherein the validating operation further comprises:
performing a type validation operation on said one or more data elements in the XML file.

11. The method of claim 8, wherein the validating operation further comprises:
performing a logic validation operation on said one or more data elements in the XML file.

12. The method of claim 1, wherein the output file generated by the generating operation contains information about an oil well.

13. The method of claim 1, wherein the output file generated by the generating operation contains information about a gas well.

14. The method of claim 1, further comprising:
after the generating operation, creating an output document based on the output file.

15. The method of claim 1, further comprising:
after the generating operation, mining the output file for one or more patterns of the one or more data elements therein.

16. The method of claim 1, further comprising:
accessing a set of rules;
after the generating operation, determining whether at least one of the one or more data elements of the output file complies with at least one rule of the set of rules.

17. The method of claim 1, further comprising:
after the generating operation, storing the output file.

18. The method of claim 17, wherein the storing operation stores the output file in a persistent memory associated with the server.

19. A system for converting an extensible markup language (XML) file to data elements accessible by a server, the system comprising:
means for receiving an XML file;
means for determining a type of data provided in the XML file;
means for identifying at least one metafile associated with the type of data determined by the means for determining, wherein the metafile specifies one or more parameters present in the type of data determined by the means for determining;
means for identifying one or more data elements in the XML file corresponding to the one or more parameters; and
means for generating an output file that includes the one or more data elements.

20. The system of claim 19, wherein the means for receiving further comprises:
means for receiving, in an application server, at least one data source file; and
means for converting, at the application server, the at least one data source file into the XML file.

21. The system of claim 20, wherein the means for receiving further comprises:
means for operating an instance of a web browser in the application server, wherein said instance of the web browser provides for entry of the at least one data source file.

22. The system of claim 19, wherein the means for receiving further comprises:
means for receiving, in an application server, at least one data source file;
means for converting, at the application server, the at least one data source file into the XML file; and
means for storing the XML file.

23. The system of claim 19, wherein the XML file includes an XML tag specifying a document type, and the means for determining further comprises:
means for examining the XML tag specifying the document type.

24. The system of claim 19, wherein the metafile specifies one or more instructions for manipulating the one or more data in the XML file.

25. The system of claim 19, further comprising:
means for creating a plurality of metafiles wherein at least one metafile corresponds to the type of data in the XML file;
and wherein the means for identifying at least one metafile accesses the plurality of metafiles to determine the at least one metafile.

26. The system of claim 19, further comprising:
means for validating the one or more data elements in the XML file.

27. The system of claim 26, wherein the means for validating further comprises:
means for performing a form validation operation on said one or more data elements in the XML file.

28. The system of claim 26, wherein the means for validating further comprises:
means for performing a type validation operation on said one or more data elements in the XML file.

29. The system of claim 26, wherein the means for validating further comprises:
means for performing a logic validation operation on said one or more data elements in the XML file.

30. The system of claim 19, wherein the output file generated by the means for generating contains information about an oil well.

31. The system of claim 19, wherein the output file generated by the means for generating contains information about a gas well.

32. The system of claim 19, further comprising:
means for creating an output document based on the output file.

33. The system of claim 19, further comprising:
means for mining the output file for one or more patterns of the one or more data elements therein.

34. The system of claim 19, further comprising:
means for accessing a set of rules;
means for determining whether at least one of the one or more data elements of the output file complies with at least one rule of the set of rules.

35. The system of claim 19, further comprising:
means for storing the output file.

36. The system of claim 35, wherein the means for storing stores the output file in a persistent memory associated with the server.

37. A system for converting source data into a data format suitable for processing by a web application server, comprising:
a server which receives the source data after it has been converted into an extensible markup language (XML) format and converts the received data into one or more data elements;
a data server in which the data elements are saved in one or more files; and
a web application server which accesses the at least one or more files from the data server and manipulates the data elements thereof to provide an output to a client system connected to the web application server.

38. A computer program product, comprising:
a computer usable medium and computer readable code embodied on said computer usable medium for converting an extensible markup language (XML) file to data elements accessible by a server, the computer readable code comprising:
computer readable program code devices configured to cause the computer to effect a receiving of an XML file;
computer readable program code devices configured to cause the computer to effect a determining of a type of data provided in the XML file;
computer readable program code devices configured to cause the computer to effect an identifying of at least one metafile associated with the type of data determined by the determining operation, wherein the metafile specifies one or more parameters present in the type of data determined by the determining operation;
computer readable program code devices configured to cause the computer to effect a identifying of one or more data elements in the XML file corresponding to the one or more parameters; and
computer readable program code devices configured to cause the computer to effect a generating of an output file which includes the one or more data elements.
